(19) United States
(12) Patent Application Publication
(10) Pub. No.: US 2017/0371068 A1
(43) Pub. Date: Dec. 28, 2017

(54) PROCESS AND METHOD FOR REMOTELY MEASURING AND QUANTIFYING CARBON DIOXIDE SEQUESTRATION FROM OCEAN IRON ENRICHMENT

(71) Applicant: Lucent Biosciences, Inc., Vancouver (CA)

(72) Inventor: Peter Gross, West Vancouver (CA)

(21) Appl. No.: 15/534,718

(22) PCT Filed: Dec. 8, 2015
(86) PCT No.: PCT/CA2015/051289

§ 371 Date: Jun. 9, 2017

(30) Foreign Application Priority Data
Dec. 9, 2014 (CL) 3350-2014

(51) Int. Cl. G01V 9/00; C01B 32/55; G01B 11/06; G01B 15/02

(52) U.S. Cl. CPC G01V 9/00; G01B 15/02; C01B 32/55; G01B 11/06

(57) ABSTRACT

Disclosed is a method and process for measuring oceanographic parameters that may be used to create estimates of the quantity of carbon dioxide gas that is removed from the atmosphere from an Ocean Iron Enrichment event. This process uses data observations from Autonomous Underwater Vehicles, Satellite observations and/or Unmanned Aerial Vehicles to determine metrics such as chlorophyll, temperature, turbidity, oxygen, particulate inorganic carbon etc. that may be used to calculate the total anthropogenic carbon dioxide that is removed from the atmosphere. Therefore, the carbon dioxide removal may be determined without requiring a manned presence in the area of study, providing a significant reduction in cost. Direct in-situ measurements of carbon flux through analysis of physical samples through the water column may be used as a verification/calibration metric using sediment traps spaced vertically in the water column from surface to the deep thermocline layer. Alternatively, water samples may be collected and used as an alternative.

### FIELD OF THE INVENTION

This invention relates to oceanography, climatology, and greenhouse gas reduction. Specifically, the present invention relates to methods and a process for measuring key data metrics and how these metrics can be used to measure the quantity of carbon dioxide removed from the atmosphere for a requisite period of time. The carbon dioxide removed from the atmosphere may subsequently be converted into a carbon emission reduction credit.

### BACKGROUND OF THE INVENTION

Ocean Iron Enrichment, also known as Ocean Iron Fertilization or Iron Fertilization is the addition of iron into the surface of the ocean to stimulate a phytoplankton bloom. This is intended to improve biological productivity of the ocean. As phytoplankton grows, it creates a food source for other organisms such as zooplankton, which are subsequently consumed by various larger organisms such as marine cetaceans, fish and others.

Phytoplankton also consumes large quantities of carbon dioxide through Photosynthesis. As the phytoplankton consumes carbon dioxide and light, it releases oxygen and glucose. Because phytoplankton is highly abundant in the world's oceans, the process of Ocean Iron Enrichment may be a highly effective technique to improve the biodiversity of the Ocean and to remove very large quantities of carbon dioxide from the atmosphere.

Phytoplankton requires small concentrations of iron to enable photosynthesis. Because ocean iron concentrations have lessened notably over the last 50 years, the lack of iron limits the photosynthesis of phytoplankton. Intentional replacement of iron into the ocean to increase phytoplankton abundance is known as Ocean Iron Enrichment.

An Iron enriched plankton bloom sequesters carbon from the atmosphere. In order to measure the total amount of carbon dioxide that is removed from the atmosphere and sequestered into the deep ocean, several key data metrics must be obtained.

Smetacek, V et al. Deep carbon export from a Southern Ocean iron-fertilized diatom bloom. Nature 11229 (2012) discloses a Carbon Chlorophyll ration (C/Chl, mg/mg) of 32. If new research provides an improved estimate of C/Chl then this improved estimate may be substituted. This metric may also be verified or updated by the use of sediment traps, or water samples in situ, to collect vertical carbon flux in the water column.

Previously these metrics were collected from manned surface vessels, using manually deployed sensors. The cost of operating a scientific equipped surface vessel, with the additional costs of personnel is prohibitive and excludes analysis of an Ocean Iron Enrichment event to all but the most profoundly funded organizations. Private industrial applications of Ocean Iron Enrichment are also limited by the cost of obtaining the data that may be used to determine the total amount of carbon dioxide sequestration.

### PRIOR ART

In the field of measuring oceanographic parameters are described methods for simulating some features related to plankton growing and the calculation of those parameters in order to take specifics actions.

Patent document WO 2008131472 A1 (Jones) entitled “Carbon Sequestration using a floating Vessel” with priority day of Apr. 27, 2007 discloses method for removing carbon dioxide from the atmosphere. The method comprises the step of delivering a urea compound from a floating vessel for stimulating plankton growth.

Patent document WO 2009062093 A1 (Climos) entitled “Quantification and quality grading for carbon sequestered via ocean fertilization” with priority day of Nov. 7, 2007, discloses a computer software manifestation that is used to calculate various parameters about carbon sequestered via ocean fertilization. This patent is centered around calculations from pre-existing ocean data.

Patent document WO 2009062097 (Climos) entitled “Ocean fertilization project identification and inventorying” with priority day of Nov. 7, 2007, is concerned with making calculations from pre-existing data. The method comprising: identifying an ocean fertilization project location in which carbon has been sequestered; calculating a number of predetermined mass units of the sequestered carbon stored by the ocean fertilization project; associating an identifier with each of the predetermined mass units of the sequestered carbon; indexing the identifiers for the ocean fertilization project in a projecting tracking database.

Because most data metrics are obtained from remotely operated sensors, the cost of determining total carbon dioxide sequestration is much less than using manned surface vessels, manned submersibles or manned aircraft.

### SUMMARY OF THE INVENTION

This invention uses a unique combination of remote sensing tools and an in situ vertical carbon flux capture device to obtain the data metrics for calculating total carbon dioxide sequestration without requiring a manned presence in the area of study.

In addition, the invention describes a process and method for acquiring data from ocean. The documents of Climos are materially different. Those documents are related to the calculation of parameters related to ocean fertilization and not with the acquiring data.

### BRIEF DESCRIPTION OF THE DRAWINGS

FIG. 1 is a conceptual diagram illustrating a method for remotely measuring and quantifying carbon, showing the main means used to collect the data according to an embodiment of the invention.

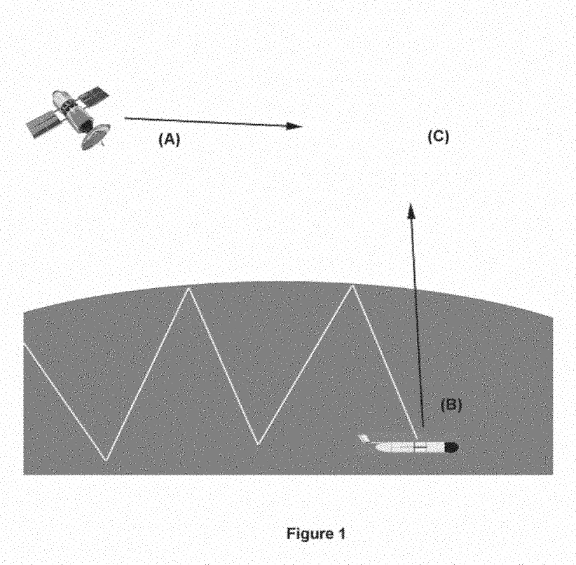

### DETAILED DESCRIPTION

The present invention is related to a method and process for measuring oceanographic parameters that may be used to create estimates of the quantity of carbon dioxide gas that is removed from The atmosphere from an Ocean Iron Enrichment event.

According to the preferred embodiment of the invention, the data requirements for determining carbon dioxide sequestration into the open (pelagic) ocean through remote means comprise measurement of Chlorophyll concentrations from the ocean surface to the first optical depth and/or Particulate Organic Carbon (POC) concentrations from the ocean surface to the deep thermocline by using autonomous measurement instruments.

In an embodiment of the invention, the Chlorophyll concentrations are obtained from Satellite observations of Chlorophyll-A (A). Surface carbon fixation may be estimated as Particulate Organic Carbon which is estimated using a Carbon to Chlorophyll conversion ratio (C/Chl). In the absence of satellite observations, Chlorophyll observations from an unmanned areal vehicle (UAV) or drone or any other telecontrolled means, shall be substituted.

The second step is the obtaining of Ocean Subsurface Measurements, between the Surface to 200 meters or more, specifically the measurements of Chlorophyll concentration (Chlorophyll-A). These readings will be accomplished utilizing an Autonomous Underwater Vehicle (AUV) from surface to a depth of not less than 100 meters (B). This Chlorophyll measurement will used as a term in a Carbon to Chlorophyll conversion ratio (C/Chl) to determine Particulate Organic Carbon in the subsurface.

A transmissometer or Particulate Organic Carbon sensor mounted on an AUV can be used to measure Particulate Organic Carbon directly as an alternative to estimating Particulate Organic Carbon via Chlorophyll, or in combination with measurements of Chlorophyll to determine metrics for Particulate Organic Carbon.

The final step is obtaining physical samples of carbon transport, between the surface to 200 meters or more. According to the invention, the physical samples comprises sediment traps that collect vertical carbon flux physically and/or Water samples containing vertical carbon flux which may be subjected to laboratory analysis to determine carbon concentration. Finally, the satellite data an subsurface data are sent to remote facility for analysis and carbon quantification (C).

The physical samples of vertical carbon flux may be collected within the area of interest to calibrate the information collected from remote sensors as stated before.

1. A method for remotely measuring and quantifying carbon dioxide sequestration from Ocean Iron Enrichment comprises by using remote measurements of chlorophyll using a combination of remote sensing devices including satellite data, unmanned aerial and/or underwater vehicles, wherein the method comprise the steps of:
a. measure a Chlorophyll concentrations from the ocean surface to the first optical depth and/or Particulate Organic Carbon (POC) concentrations from the ocean surface to the first optical depth by using remote measurements;
b. obtain of Ocean Subsurface Measurements, between the Surface to 200 meters or more, specifically the measurements of Chlorophyll concentration (Chlorophyll-A) and Transmissivity or Particulate Organic Carbon which may be substituted for Chlorophyll concentration; and
c. obtain physical samples of carbon transport, between the surface to 200 meters or more.

2. The method for remotely measuring and quantifying carbon dioxide sequestration from Ocean Iron Enrichment according to claim 1, wherein the ocean surface Chlorophyll is remotely sensed and used to provide estimates of carbon sequestration from the ocean surface layer.

3. The method for remotely measuring and quantifying carbon dioxide sequestration from Ocean Iron Enrichment according to claim 2, wherein Chlorophyll readings are obtained from the ocean surface using satellite observations of Chlorophyll-A.

4. The method for remotely measuring and quantifying carbon dioxide sequestration from Ocean Iron Enrichment according to claim 2, wherein the surface carbon sequestration as particulate organic carbon from the ocean surface to the first optical depth can thereby be calculated using a C/Chl (mg/mg) ratio.

5. The method for remotely measuring and quantifying carbon dioxide sequestration from Ocean Iron Enrichment according to claim 4, wherein in the absence of satellite observations, multispectral Chlorophyl observations from an unmanned aerial vehicle (UAV) containing chlorophyll measurement equipment can be substituted for satellite observations of chlorophyll.

6. The method for remotely measuring and quantifying carbon dioxide sequestration from Ocean Iron Enrichment according to claim 5, wherein the subsurface ocean Chlorophyll is used to provide estimates of carbon sequestration beneath the sea surface.

7. The method for remotely measuring and quantifying carbon dioxide sequestration from Ocean Iron Enrichment according to claim 6, wherein the subsurface readings of Chlorophyl are obtained using an Autonomous Underwater Vehicle (AUV).

8. The method for remotely measuring and quantifying carbon dioxide sequestration from Ocean Iron Enrichment according to claim 7, wherein the subsurface readings of Chlorophyl from surface to a depth of not less than 100 meters are used to provide estimates of Particulate Organic Carbon below the first optical depth of satellite observations.

9. The method for remotely measuring and quantifying carbon dioxide sequestration from Ocean Iron Enrichment according to claim 7, wherein subsurface carbon sequestration as Particulate Organic Carbon is calculated using a C/Chl (mg/mg) ratio.

10. The method for remotely measuring and quantifying carbon dioxide sequestration from Ocean Iron Enrichment according to claim 9, wherein total carbon sequestration is a sum of carbon sequestration from the ocean surface layer and subsurface carbon sequestration.

11. The method for remotely measuring and quantifying carbon dioxide sequestration from Ocean Iron Enrichment according to claim 7, wherein a transmissometer or Particulate Organic Carbon sensing device mounted on an AUV can be used to measure Particulate Organic Carbon directly as an alternative to estimating Particulate Organic Carbon via Chlorophyll, or in combination with measurements of Chlorophyll to determine metrics for Particulate Organic Carbon.

12. The method for remotely measuring and quantifying carbon dioxide sequestration from Ocean Iron Enrichment according to claim 1, wherein physical samples of vertical carbon flux may be collected within an area of interest to calibrate the information collected from the remote sensing devices.
